(19) United States
(12) Patent Application Publication
(10) Pub. No.: US 2023/0071799 A1
(43) Pub. Date: Mar. 9, 2023

(54) SYSTEM AND METHOD FOR EXTRACTING SUGGESTIONS FROM REVIEW TEXT

(71) Applicant: Accenture Global Solutions Limited, Dublin (IE)

(72) Inventors: Roshni Ramesh Ramnani, Bangalore (IN); Shubhashis Sengupta, Bangalore (IN)

(21) Appl. No.: 17/810,775

(22) Filed: Jul. 5, 2022

(30) Foreign Application Priority Data
Aug. 30, 2021 (IN) 202141039130

(51) Int. Cl. G06F 40/166; G06F 40/30; G06F 40/279; G06F 40/205; G06F 40/232; G06F 40/253; G06F 40/247; G06N 3/08; G06N 3/04

(52) U.S. Cl. CPC G06F 40/166; G06F 40/30; G06F 40/279; G06F 40/205; G06F 40/232; G06F 40/253; G06F 40/247; G06N 3/082; G06N 3/0454

(57) ABSTRACT

A system and method for extracting suggestions from review text is disclosed. The disclosed methods include utilizing natural language processing techniques and knowledge graphs to extract implicit suggestions from review text. In this way, conflicting descriptions can be eliminated and similar descriptions can be consolidated. In later operations, the pruned knowledge graphs may be converted into textual summaries to provide more concise suggestions from the raw review text.

### CROSS-REFERENCE TO RELATED APPLICATION(S)

This application claims priority to Indian Provisional Patent Application 202141039130, entitled “System and Method for Extracting Suggestions from Customer Reviews”, filed on Aug. 30, 2021 (Attorney Docket No. 164-1135), the entirety of which is hereby incorporated by reference.

### TECHNICAL FIELD

The present disclosure generally relates to natural language processing. More specifically, the present disclosure generally relates to a system and method for extracting suggestions from review text.

### BACKGROUND

A valuable trove of information exists for product(s) or services online via user opinions like detailed reviews provided by customers on popular e-commerce websites. Users express their individual opinions in the form of overall product/service experiences, which may include explicit positive/negative feedback, preferences, concerns, and suggestions for the future. Such information can be valuable to product/service owners in helping them understand the improvement(s) that can be made to a particular product or service.

The primary focus of opinion mining has been on understanding positive and negative aspects within the review effectively. Limited emphasis has been placed on finer topics like user suggestions or conflicting information from users. Also, very limited software exists in the commercial space, which can extract actionable information from online review text.

There is a need in the art for a system and method that addresses the shortcomings discussed above.

### SUMMARY

A system and method for extracting suggestions from review text is disclosed. The disclosed methods include building knowledge graphs from review text and applying Natural Language Processing (NLP) techniques to the knowledge graphs to find conflicts or duplicative language that can be used to prune the knowledge graphs. The pruned knowledge graphs facilitate finding user suggestions that may have been hidden in the wording of a review text. The pruned knowledge graphs may also simplify suggestions by eliminating conflicting descriptions and by consolidating similar descriptions. In later operations, the pruned knowledge graphs may be converted into textual summaries to provide more concise suggestions from the raw review text.

In one aspect, the disclosure provides a method of extracting suggestions from review text. The method may include receiving raw review text. The method may include pre-processing the raw review text by applying neural parsing to the raw review text to output simplified text. The method may include applying an NLP library to classify the simplified text as subjective text or objective text. The method may include building a knowledge graph from the subjective text, wherein the knowledge graph includes noun nodes and attribute nodes. The method may include identifying conflicting attribute nodes connected to the same noun node within the knowledge graph. The method may include pruning the conflicting attribute nodes from the knowledge graph to create a pruned knowledge graph. The method may include applying a first machine learning model to the pruned knowledge graph to output a text summarization of the simplified text.

In another aspect, the disclosure provides a non-transitory computer-readable medium storing software that may comprise instructions executable by one or more computers which, upon such execution, cause the one or more computers to: (1) receive raw review text; (2) pre-process the raw review text by applying neural parsing to the raw review text to output simplified text; (3) apply a Natural Language Processing (NLP) library to classify the simplified text as subjective text or objective text; (4) build a knowledge graph from the subjective text, wherein the knowledge graph includes noun nodes and attribute nodes; (5) identify conflicting attribute nodes connected to the same noun node within the knowledge graph; (6) prune the conflicting attribute nodes from the knowledge graph to create a pruned knowledge graph; and (7) apply a first machine learning model to the pruned knowledge graph to output a text summarization of the simplified text.

In another aspect, the disclosure provides a system for extracting suggestions from review text, comprising one or more computers and one or more storage devices storing instructions that may be operable, when executed by the one or more computers, to cause the one or more computers to: (1) receive raw review text; (2) pre-process the raw review text by applying neural parsing to the raw review text to output simplified text; (3) apply a Natural Language Processing (NLP) library to classify the simplified text as subjective text or objective text; (4) build a knowledge graph from the subjective text, wherein the knowledge graph includes noun nodes and attribute nodes; (5) identify conflicting attribute nodes connected to the same noun node within the knowledge graph; (6) prune the conflicting attribute nodes from the knowledge graph to create a pruned knowledge graph; and (7) apply a first machine learning model to the pruned knowledge graph to output a text summarization of the simplified text.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features, and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 shows the general flow of extracting suggestions from review text, according to an embodiment.

FIG. 2 shows a method of extracting suggestions from review text (or method 200), according to an embodiment.

FIG. 3 shows an example of review text, according to an embodiment.

FIG. 4 shows a dependency graph as outputted by a parser, according to an embodiment.

FIG. 5 shows a knowledge graph built from the words in review text, according to an embodiment;

FIG. 6 shows another knowledge graph with positive sentiments about food from restaurant reviews, according to an embodiment.

FIG. 7 shows an example of different positive knowledge graphs covering multiple aspects, according to an embodiment.

FIG. 8 shows an example of a negative knowledge graph, according to an embodiment.

FIG. 9 shows an example of a knowledge graph about a room of a hotel and a knowledge graph about a bathroom of a hotel, according to an embodiment.

FIG. 10 shows a pruned knowledge graph, according to an embodiment.

FIG. 11 is a schematic diagram of a system for extracting suggestions from review text, according to an embodiment.

### DESCRIPTION OF EMBODIMENTS

A system and method for extracting suggestions for product and/or service improvements from opinionated text is disclosed. For example, opinionated text may be in the form of non-conflicting negative feedback, user tips, recommendations, product usage details, feature suggestions, and/or specific complaints. Opinions towards persons, brands, products, or services are generally expressed through online reviews, blogs, discussion forums, or social media platforms. In many cases, the opinionated text may come from customer reviews, but in other cases, the opinionated text may come from other places, such as questions and answers provided about a product and/or service. However, for the purpose simplicity in this application, review text is meant to refer to any opinionated text about a product and/or service.

Actionable information from reviews can take the form of explicit suggestions, such as, “I would suggest you include a work desk in the room” to implicit criticism, such as, “the only thing I don't like about the phone is that it does not come in red color”. Additionally, explicit recommendations in the form of tips provided to other customers can also be valuable in understanding what features or aspects customers tend to focus on.

Generation of insights from user reviews generally called “Opinion Mining” has in most cases been conceptualized as Aspect based Sentiment Analysis (ABSA). ABSA involves finding out user sentiments around specific aspects of a product or service/topic. Rather than simply finding out opinions about products or services, this disclosure focuses on extracting constructive suggestions that can be used to modify products or services.

In opinionated text, suggestions may be explicit—“I would suggest . . . ”, “please release” or implicit “I love how great these shoes are for running in the woods or “the only drawback I see of the phone is that it does not come in red color.” Suggestions can also be in the form of tips or advice to other customers. Suggestions extracted from opinions may lead to changes in products/services, help target new customers etc.

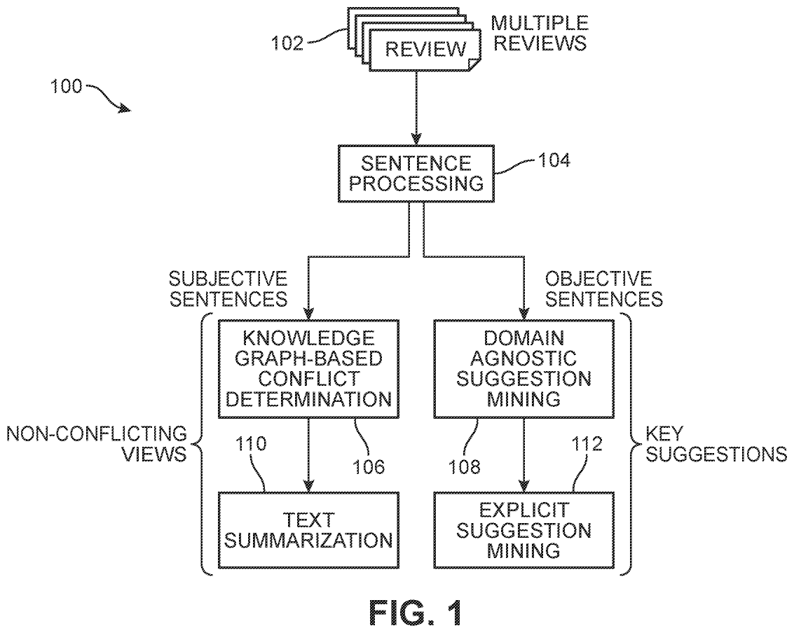

FIG. 1 shows the general flow 100 of extracting suggestions from review text, according to an embodiment. Review text 102 may be input into a sentence processing module 104, where the review text may be pre-processed into a more suitable format for analysis, then classified as either objective or subjective, and then sent to the next modules based upon classification. Pre-processed text that is classified as subjective may be input into a knowledge graph-based conflict determination module 106. Pre-processed text that is classified as objective may be input to a domain agnostic suggestion mining module 108. Knowledge graph-based conflict determination module 106 can output knowledge graphs that are used as input by text summarization module 110 to create simplified text summarizing suggestions. Domain agnostic suggestion mining module 108 can output training data that can be used by an explicit suggestion mining module 112. Explicit suggestion mining module 112 can classify objective text as explicit suggestions or not explicit suggestions.

The method of extracting suggestions from review text may involve using review text as input and outputting suggestions extracted from the review text. In some embodiments, the extracted suggestions may be formatted in the original language of the review text. Additionally or alternatively, the extracted suggestions may be formatted in simplified language created as part of the process of extracting the suggestions. For example, the embodiment discussed with respect to FIGS. 1-11 includes extracting explicit suggestions from review text classified as objective, and these explicit suggestions are left in their original form. The embodiment discussed with respect to FIGS. 1-11 also includes summarizing the review text that is classified as subjective. The subjective review text is more likely to include implicit suggestions. Thus, rewording or summarizing the subjective review text helps illuminate the suggestion that may be hidden within the original wording.

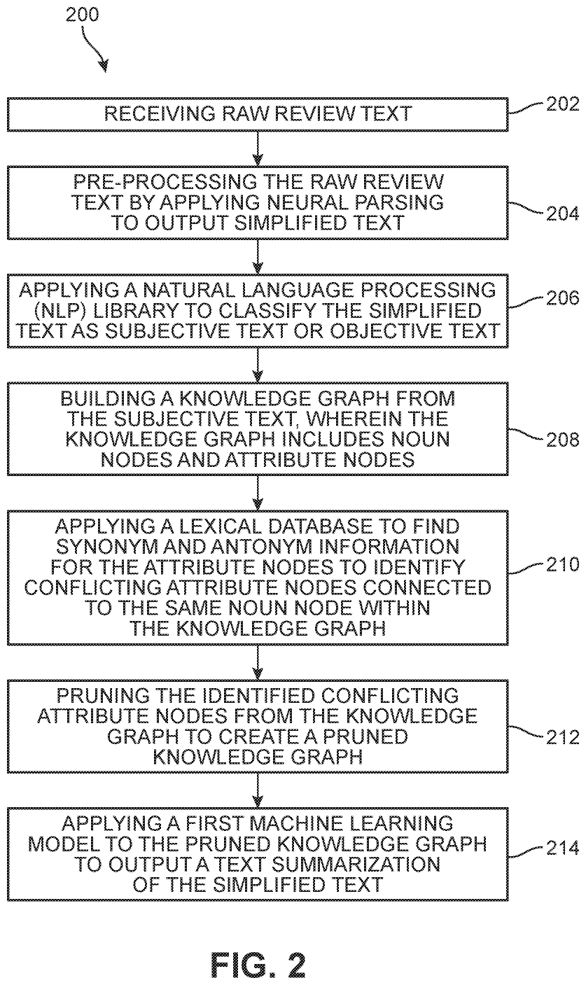

FIG. 2 shows a method of extracting suggestions from review text 200 (or method 200), according to an embodiment. Method 200 includes receiving raw review text (operation 202). Method 200 includes pre-processing the raw review text by applying neural parsing to output simplified text (operation 204). Method 200 includes applying a Natural Language Processing (NLP) library to classify the simplified text as subjective text or objective text (operation 206). Method 200 includes building a knowledge graph from the subjective text, wherein the knowledge graph includes noun nodes and attribute nodes (operation 208). Method 200 includes identifying conflicting attribute nodes connected to the same noun node within the knowledge graph (operation 210). Method 200 includes pruning the identified conflicting attribute nodes from the knowledge graph to create a pruned knowledge graph (operation 212). Method 200 includes applying a first machine learning model to the pruned knowledge graph to output a text summarization of the simplified text (operation 214).

Opinions in reviews are typically expressed as subjective statements. Subjectivity Determination refers to distinguishing opinions from facts and can be considered a preliminary step to sentiment analysis or opinion mining. Converting user reviews into easily readable suggestions may include separating objective sentences from subjective sentences. The method may include pre-processing review text into sentences and/or independent clauses to enable classification of each sentence and/or clause as either objective or subjective. The objective sentences may be closer to a format that clearly states a suggestion. Thus, the method may include processing the objective sentences through a suggestion mining module. Since subjective sentences and/or clauses may be more indirect/implicit about suggestions, subjective sentences and/or clauses benefit from more processing to extract explicit messages from the subjective sentences and/or clauses. For example, the method may include processing the subjective sentences and/or clauses through a polarity classifier to determine the polarity (i.e., positive or negative sentiment) of the subjective sentences and/or clauses. Then, for each polarity and aspect (or feature), a knowledge graph is built.

The method of extracting suggestions from review text may include pre-processing raw review text by applying neural parsing to output simplified text (for example, see operation 204). For example, sentence processing module 104 can perform pre-processing by applying sentence detection in which a paragraph is broken up into sentences (or clauses). Then, in downstream operations, sentence processing module 104 can determine the sentiment (or polarity) of each sentence separately. User reviews tend to have run-on sentences, i.e., multiple independent clauses within the same sentence without the appropriate punctuation. Thus, during pre-processing, multiple clauses in a sentence may also be separated. For example, in some embodiments, sentence detection and clause separation may be performed using neural networks and self-attention applied by a Natural Language Processing (NLP) model, such as Berkley Neural Parser (see Nikita Kitaev and Dan Klein. Constituency Parsing with a Self-Attentive Encoder. arXiv preprint arXiv:1805.01052 (2018), which is hereby incorporated by reference in its entirety).

Once a paragraph is broken up into sentences and/or sentences are broken up into clauses, the sentence processing module may review and correct the spelling and grammar of the sentences and/or clauses. For example, in some embodiments, the sentence processing module may apply a spellchecking library, such as JamSpell (see, https://github.com/bakwc/JamSpell), to automatically perform spellchecking and correction. Automatically performing spellchecking may include automatically spellchecking words of the one or more sentences to identify misspelled words. Automatic correction may include automatically correcting the identified misspelled words of the words of the one or more sentences. To reiterate, the sentence processing module can break sentences up into discrete statements (sentences or clauses) and then apply the spellchecking library to refine the discrete statement. This process may result in simplified text. In other words, the output of the sentence processing module can be simplified text, which enhances the speed and accuracy of downstream operations of extracting suggestions from the original raw text.

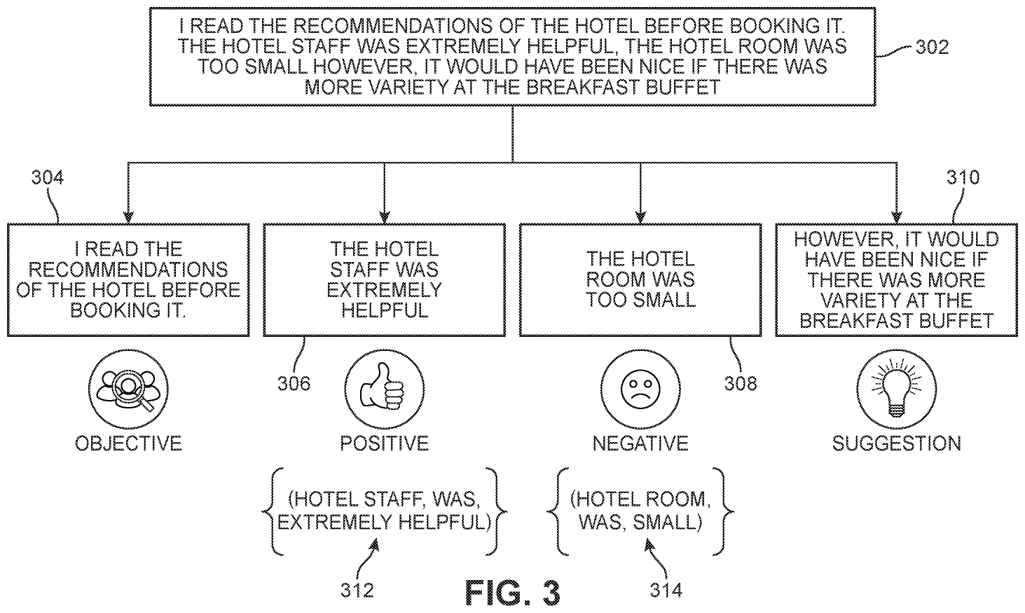

FIG. 3 shows an example of review text 302, which includes the following: “I read the recommendations of the hotel before booking it. the hotel staff was extremely helpful, the hotel room was too small, however it would have been nice if there was more variety at the breakfast buffet.” As shown in FIG. 3, the output of sentence processing module 104 may result in four simple sentences: “I read the recommendations of the hotel before booking it” 304, “the hotel staff was extremely helpful” 306, “the hotel room was too small” 308, and “however it would have been nice if there was more variety at the breakfast buffet” 310.

After pre-processing the raw review text, the method may include classifying discrete sentences of clauses of simplified text as subjective or objective (see, for example, operation 206). For subjective sentences the polarity (i.e., positive or negative sentiment) is determined. In some embodiments, the raw review text may be classified as subjective or objective without pre-processing the raw review text.

Subjectivity and polarity may be determined by using an NLP library, such as TextBlob (see https://textblob.readthedocs.io/en/dev/, which is incorporated by reference in its entirety) or Flair. For example, an NLP library may be utilized to classify a sentence or clause as subjective or objective. The subjective sentences may be further classified as negative or positive sentiments (i.e., polarity). As discussed below, subjective sentences may be passed to the knowledge graph generation module for conflict resolution. The objective sentences may then be passed to the Suggestion Mining modules. Most users mainly provide feedback on aspects of the product or the service they liked or disliked (e.g., ABSA), sometimes in very short sentences. This type of feedback mechanism can be easily represented as a knowledge graph(s). However, because suggestions are fewer and more detailed, a classification approach may be taken to extract them.

Table 1 below shows the results of analyzing review text 302 for subjectivity and polarity. FIG. 3 also shows that sentence 304 is classified as objective, sentence 306 is classified as subjective and positive, sentence 308 is classified as subjective and negative, and sentence 310 is classified as objective and as a suggestion. Sentence 304 is simply objective because the information in the sentence does not provide a suggestion. FIG. 3 also shows the output of text summarization module 110, which can include first simplified text 312 and second simplified text 314, which both summarize suggestions existing in review text 302.

TABLE 1
Example Subjectivity and Polarity Classification

| Review Sentence | Is Subjective | Polarity |
|---|---|---|
| I read the recommendations of the | False | N/A |
| hotel before booking it | | |
| (304) | | |
| The hotel staff was extremely helpful (306) | True | Positive |
| The hotel room was too small (308) | True | Negative |
| However it would have been nice if there | False | N/A |
| was more variety | | |
| at the breakfast buffet (310) | | |

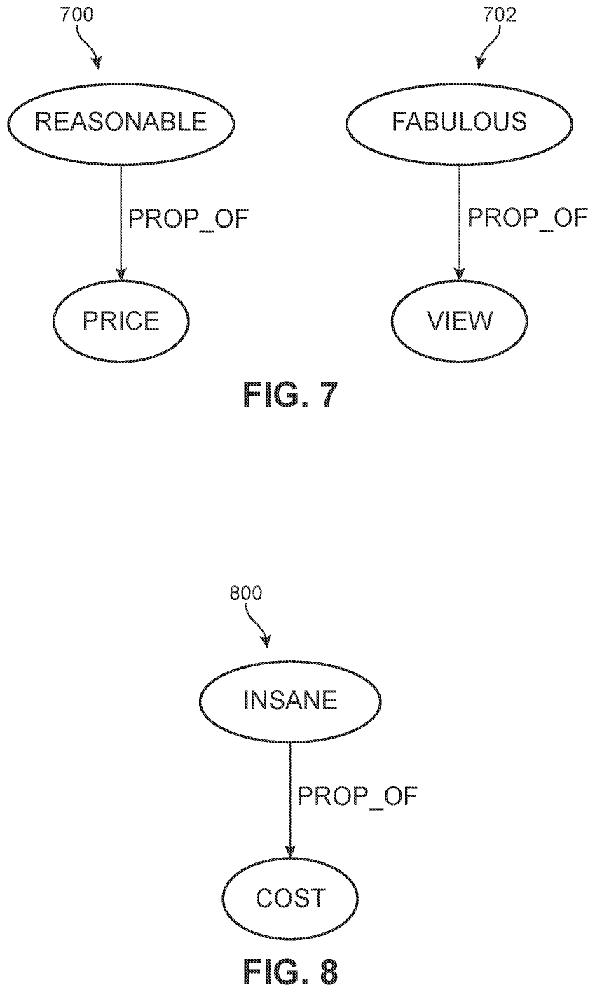

The method may include building knowledge graphs based on the output of sentence processing module 104 (see, for example, operation 208). Separate knowledge graphs may be created per aspect per sentiment. For example, FIG. 8 shows a negative sentiment knowledge graph 800 (or knowledge graph 800) for the aspect of cost. In another example, FIG. 7 shows a positive sentiment knowledge graph 700 (or knowledge graph 700) for the aspect of price and a positive sentiment knowledge graph 702 (or knowledge graph 702) for the aspect of view. Triple extraction may be applied to build knowledge graphs. Knowledge graph consolidation may then be applied to eliminate duplicates. In some embodiments, knowledge graph consolidation may include identifying conflicting attribute nodes connected to the same noun node within the knowledge graph. For example, the method may include applying a lexical database to find synonym and antonym information for the attribute nodes to identify conflicting attribute nodes connected to the same noun node within the knowledge graph. Knowledge graph-based conflict determination module 106 may build, analyze, and modify knowledge graphs in the manner discussed below.

In some embodiments, building knowledge graphs may include sending the sentences and/or clauses output from sentence processing module 104 through a parser. For example, in some embodiments, the parser may be the dependency parser of SpaCy (see, for example, https://github.com/explosion/spaCy), Natural Language Toolkit (NLTK), or Berkley Neural Parser (Benepar). The parser may tag each word or multi-word term as per its part-of-speech, the dependency role it plays, and mark the dependencies between the words. In some embodiments, the dependency tree tags may follow standard nomenclature as described in the Universal Dependencies (UD) set (e.g., see https://universaldependencies.org/).

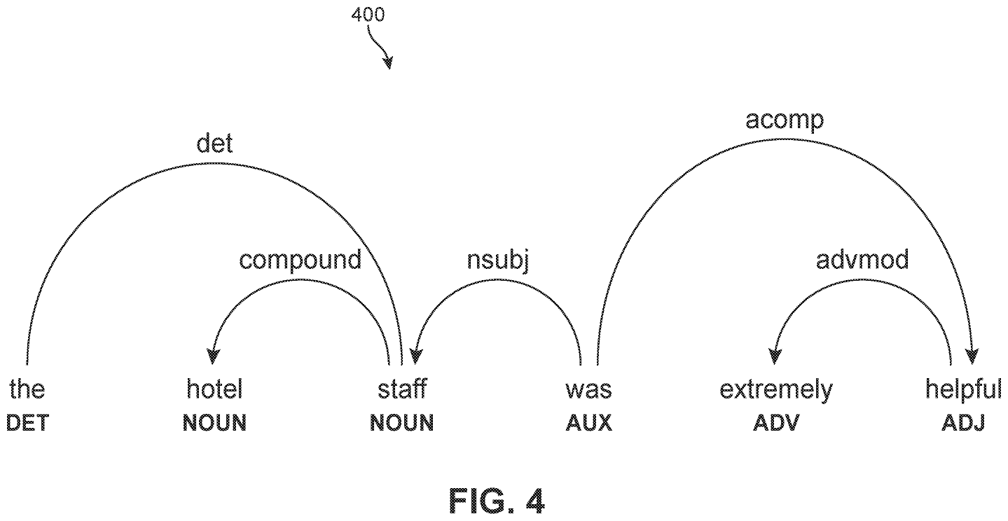

FIG. 4 shows a dependency graph 400 outputted by a parser, according to an embodiment. As can be seen in dependency graph 400, the dependency parser tags each word with its part-of-speech, the dependency role it plays, and marks the dependencies between the words. In FIG. 4, the sentence “the hotel staff was extremely helpful” is shown with the part-of-speech beneath each word. For example, “the” is tagged as a determiner with the abbreviation of “det.” “Hotel” and “staff” are tagged as nouns. “Was” is tagged as an auxiliary verb with the abbreviation of “aux.” “Extremely” is tagged as an adverb with the abbreviation of “adv.” “Helpful” is tagged as an adjective with the abbreviation of “adj.”

In dependency graph 400, the relationship between certain words in the sentence are shown with arrows and explanatory words under the arrows. For example, an arrow indicates that “staff” is dependent on “the” and the arrow is tagged with the abbreviation “det” indicating that “the” is the determiner for “staff.” Another arrow indicates that “staff” is dependent on “hotel” and the arrow is tagged with “compound” indicating that “hotel” is a compound noun with “staff.” Another arrow indicates that “was” is dependent on “staff” and the arrow is tagged with the abbreviation “nsubj” indicating that “staff” is a nominal subject. Yet another arrow indicates that “was” is also dependent on helpful and the arrow is tagged with the abbreviation “acomp” indicating that “helpful” is an adjectival complement. Finally, another arrow indicates that “extremely” is dependent on “helpful” and the arrow is tagged with the abbreviation “advmod” indicating that “extremely” is an adverbial modifier of “helpful.”

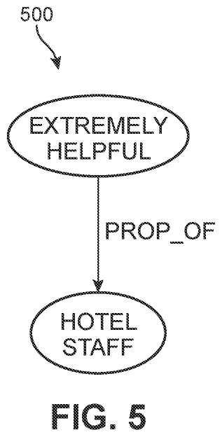

In some embodiments, building a knowledge graph may include applying set of heuristics on top of the information modeled in the dependency parser to identify the basic triples for each sentence in the form of <subject, verb, object/attribute> or <subject, prep, object/attribute>. For example, given the above statement, “the hotel staff was extremely helpful”, the dependency parser marks “Hotel Staff” as the “nsubj” of the auxiliary verb “was.” The dependency parser further marks “extremely helpful” is the “acomp” (aka adjectival complement) of the verb “was.” The dependency parser may output the following triple: <Hotel Staff, was, extremely helpful>. The triples output by the dependency parser may be used to form the nodes and edges of a knowledge graph. Examples of edges in the knowledge graph include “prop_of” (or “not_prop_of”), “prep,” and “verb.” For example, FIG. 5 shows a knowledge graph 500 with “hotel staff” as one node, “extremely helpful” as another node, and “prop_of” as the edge. A prop_of edge is formed from sentences that describe an entity or aspect in the form of a descriptive adjective. For example, the sentences “wonderful bathroom” or “bathroom is wonderful” results in a tuple of the form <wonderful, prop_of, bathroom>. A prep edge joins two nouns with a preposition. For example, the sentence “wine reception in the evening” would result in the tuple <wine reception, in, evening>. A verb edge joins two nouns with a verb, e.g., the sentence “I love this phone” would result in the tuple <I, love, phone>.

In some embodiments, software such as NetworkX or Vizgraph may be used to perform various steps of the disclosed method (e.g., building a knowledge graph and/or pruning a knowledge graph).

After building knowledge graphs from review text, the resulting knowledge graphs may be pruned. For example, triples from multiple review sentences and/or clauses may be merged into one graph. Duplicates may be eliminated by merging nodes/edges with a high degree of semantic similarity (e.g., synonyms). Similarly, antonyms may be used to identify conflicts. In other words, the knowledge graphs may be pruned to remove unimportant aspects, merge similar characteristics, and/or remove or markup conflicts.

In some embodiments, a lexical database, such as WordNet, may be used to obtain synonym and antonym information utilized for pruning. In some embodiments, a neural network model, such as Word2vec, may be additionally or alternatively applied to find the semantic similarity of Word2vec embeddings to determine synonym and antonym information for pruning.

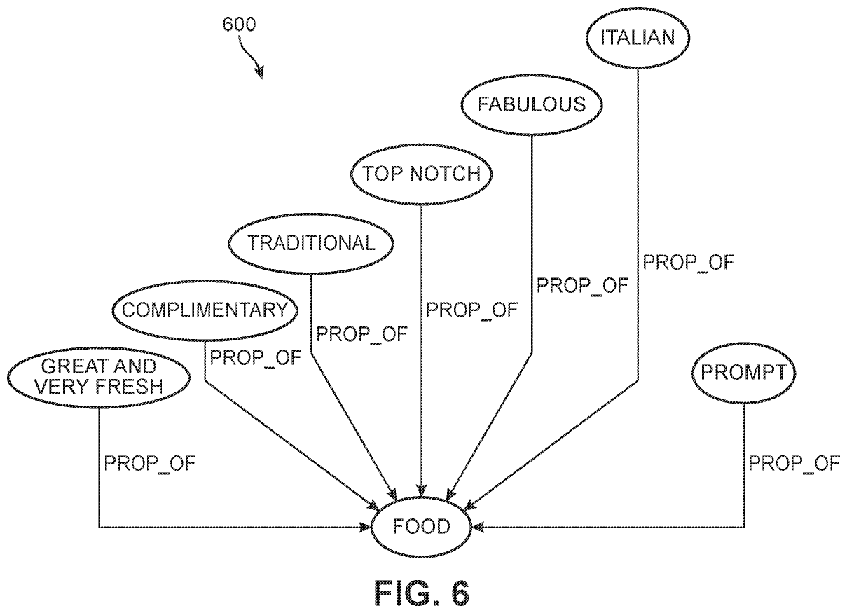

As discussed earlier, separate knowledge graphs may be created for sentiments (i.e., positive and negative statements), with a separate knowledge graph for each feature (or aspect). For example, knowledge graph 500 may be classified as a positive statement. FIG. 6 shows another knowledge graph 600 with positive sentiments about food from restaurant reviews, according to an embodiment. The words used to describe the food in the reviews are nodes connected to food. For example, the nodes connected to food include “great and very fresh,” “complimentary,” “traditional,” “top notch,” “fabulous,” “Italian,” and “prompt.” For simplicity, all nouns may be assumed to be features and all adjectives or adverbs may be assumed to be feature attributes in the knowledge graphs. Care may be taken to see that the knowledge graph created is independent of the sentence structure. As an example, the following sentences may create the same knowledge graph with the structure <helpful,propof,staff>: “the staff was helpful”, “helpful staff”, and “we found the staff to be helpful.” If these three sentences occurred in a set of reviews processed by the disclosed method, these sentences could be merged as a single knowledge graph.

FIG. 7 shows an example of different positive knowledge graphs covering multiple aspects. Positive sentiment knowledge graph 700 indicates that a price is reasonable and positive sentiment knowledge graph 702 indicates that a view is fabulous. FIG. 8 shows negative sentiment knowledge graph 800 in which a “cost” is described as “insane.”

As previously mentioned, the method may include pruning the identified conflicting attribute nodes from the knowledge graph to create a pruned knowledge graph (see, for example, operation 212). Two review statements (or graph triples) may be deemed conflicting if the attributes of a feature are antonyms of each other or if the sentiments for a particular feature are in conflict. These two types of conflicts are described below:

Type1 conflict : Attributes are antonyms of each other (e.g., “the rooms were big” versus “the rooms were small”).

Type2 conflict: Sentiments on the features are different (e.g., “the rooms were cozy” versus “the rooms were small”).

In an example where review text for the same hotel included knowledge graph 700 and knowledge graph 800, these two graphs could be considered as conflicting because these graphs include synonyms for the noun of “price” or “cost” and the adjectives of “reasonable” and “insane” are different sentiments. After constructing the initial knowledge graphs, attributes that are identified as conflicting may be pruned. Accordingly, in the example of the hotel reviews, knowledge graph 700 and knowledge graph 800 may both be pruned (eliminated, in this case), as the sentiment on the features are different/conflict. For example, in some embodiments, the method may include utilizing a sentiment look-up of words to determine whether the sentiment of attributes in a knowledge graph (or amongst multiple knowledge graphs) conflict. In another example, in some embodiments, the method may include applying one or more pretrained deep learning models on sentiment analysis to determine whether the sentiment of attributes in a knowledge graph (or amongst multiple knowledge graphs) conflict. For example, a machine learning framework, such as Pytorch, may be applied for these functions in various embodiments.

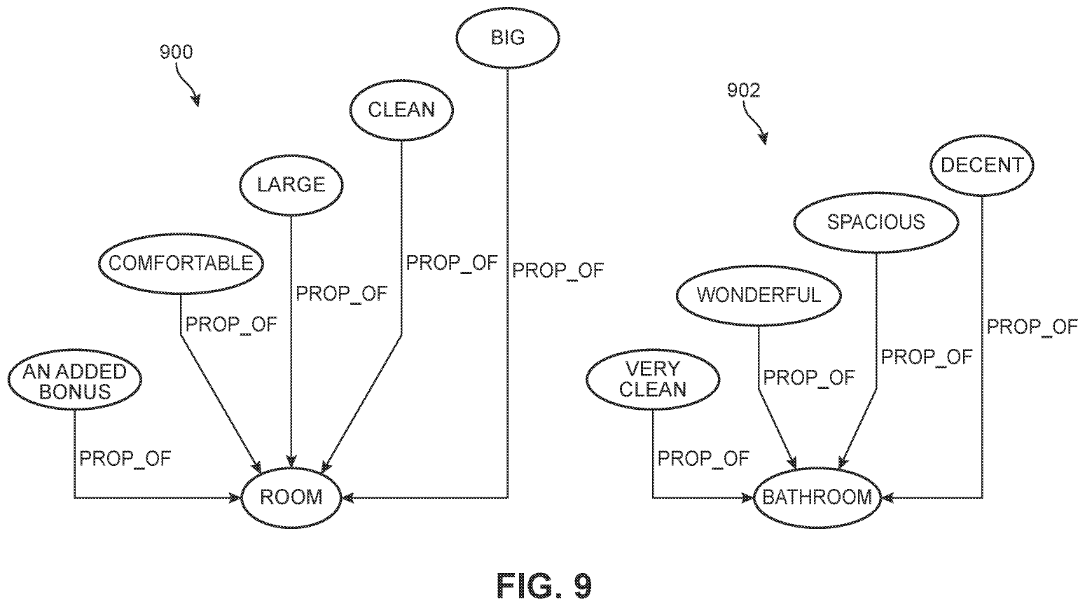

FIG. 9 shows an example of a knowledge graph 900 about a room of a hotel and a knowledge graph 902 about a bathroom of a hotel. These knowledge graphs are based on the following sentiments from reviews and the corresponding tuples created by a dependency parser:

Sen1: “Large comfortable room, wonderful bathroom.”

Tuples corresponding to Sen1: [(“large”, “prop_of”, “room”), (“comfortable”, “prop_of”, “room”), (“wonderful”, “prop_of”, “bathroom”)].

Sen2: “Bathroom was spacious too and very clean.”

Tuples corresponding to Sen2: [(“spacious”, “prop_of”, “bathroom”), (“very clean”, “prop_of”, “bathroom”)].

Sen3: “big clean rooms, decent bathroom and the free wine reception in the evening was an added bonus.”

Tuples corresponding to Sen3: [(“big”, “prop_of”, “rooms”), (“clean”, “prop_of”, “rooms”), (“decent”, “prop_of”, “bathroom”), (“free”, “prop_of”, “wine reception”), (“wine reception”, “in”, “evening”), (“an added bonus”, “prop_of”, “rooms”)].

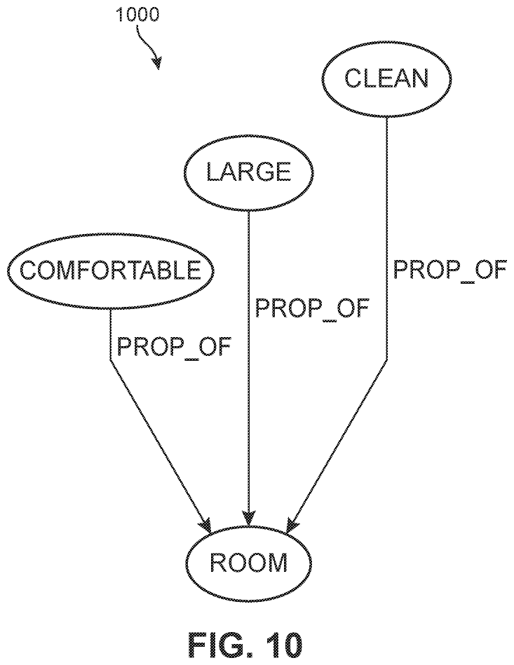

As shown in FIG. 9, separate knowledge graphs were built for the different aspects of “room” and “bathroom.” FIG. 10 shows a pruned knowledge graph 1000, which is the knowledge graph resulting from pruning knowledge graph 900. “An added bonus” was removed from knowledge graph 900 because this attribute was unimportant. In other words, this attribute did not give much information about modifications to the room that could be made. Since “big” and “large” are synonyms, these attributes were merged and knowledge graph 1000 only includes “large.”

In knowledge graph 900, “the rooms were small” would be a conflicting statement that would cause “small” to be removed as a node. In some embodiments, the conflicting statement may result in all conflicting nodes related to the size of the room to be removed. In other words, “small” and “large” would both be removed.

As previously mentioned, the method may include applying a first machine learning model to the pruned knowledge graph to output a text summarization of the simplified text (see, for example, operation 214). In some embodiments, text summarization module 110 can be used to generate a textual summary of the reviews using the intermediate knowledge graphs. The textual summary may be generated by organizing the nodes of the knowledge graphs by relative importance. For example, nodes with more attributes may be considered more important.

Text summarization module 110 may automatically examine all the nodes attached to an aspect in a knowledge graph by a “prop_of” edge. Text summarization module 110 may prioritize nodes with more than 3 words or with a preposition or conjunction as part of its content. For all the nodes attached to an aspect in a knowledge graph by a “prop_of” edge, text summarization module 110 may create a sentence of the form <aspect><is><node content>.

Method 200 may include determining whether the knowledge graph(s) includes any prep nodes attached to an aspect. Upon determining that the knowledge graph(s) includes prep nodes attached to an aspect, text summarization module 110 can create a sentence using the prep nodes and the remaining nodes attached as “prop_of” in the order of frequency of usage.

For all the verb nodes, text summarization module 110 may create simple sentences with the form <aspect><verb><object> and include all the prep nodes that are attached to <object>. Additionally, text summarization module 110 may apply sentence similarity check. For example, in some embodiments, checking for sentence similarity may include embedding sentences using any known sentence embedding method, such as GloVe embeddings, and performing a cosine similarity against every pair of sentences. Method 200 may include removing any duplicate sentences that have a similarity with a given sentence above a certain threshold. These steps can help remove duplicate properties that may have been missed at the graph processing stage.

Method 200 may include applying a sentence paraphrasing model to rephrase the sentence(s) generated by the above steps. In some embodiments, a predetermined number of paraphrases may be generated per sentence. For example, 10 paraphrases may be generated per sentence. The paraphrases may be generated by passing the sentences to a machine learning model, such as Generative Pre-trained Transformer 2 (GPT-2), which is an open-source artificial intelligence created by OpenAI (see posting of Alec Radford et al. to https://OpenAI.com/blog (2019), Language Models are Unsupervised Multitask Learners, incorporated by reference in its entirety). In some embodiments, the machine learning model can be trained in a dataset, such as the Paraphrase Adversaries from Word Scrambling (PAWS) dataset. Method 200 may include scoring paraphrases by using the perplexity of the sentence. The sentence with the best score (lowest perplexity) can be used in the final summary.

In one example of text summarization, according to an embodiment, text summarization module 110 may take knowledge graph 600 as input, eliminate duplicates, and create the following summary: “Food is fresh, Italian, complimentary, and top notch.”

In addition to extracting implicit suggestions from subjective text, the method of extracting suggestions may also include extracting explicit suggestions from review text. As discussed above, pre-processed text that is classified as objective may be input to and processed through a domain agnostic suggestion mining module 108. Domain agnostic suggestion mining module 108 can output objective text classified as explicit suggestions and/or training data that can be used by explicit suggestion mining module 112. Explicit suggestion mining module 112 can classify objective text as explicit suggestions or not explicit suggestions.

Domain agnostic suggestion mining module 108 may perform suggestion mining without the use of training data. For example, domain agnostic suggestion mining module 108 may include a one-shot model, such as Task-Aware Representation of Sentences for Generic Text Classification (TARS), which is described by Kishaloy Halder et al. in Task-Aware Representation of Sentences for Generic Text Classification in Proceedings of the 28th International Conference on Computational Linguistics (2020) at 3202-3213. TARS performs classification tasks by understanding the semantic similarity between sentences and their labels. To mine suggestions in a domain agnostic way, the one-shot model may use seed label categories. For example, the following set of seed label categories or label words may be used by the one-shot model: tip/directive/advice, recommend/suggest, warning/consequence/danger, provision/provide, should not, complaint, request/wish, wrong choice/look for alternatives, usage characteristic, and/or disability.

Table 2 shows examples of sentences identified/classified as suggestions in review statements from electronic reviews as part of the Opinosis Dataset.

TABLE 2
Sample Suggestions from Electronic Reviews

Review Sentence
The voice directions are great, but sometimes it mispronounces names
I would love a case cover that’s well made and doesn’t cost a third the price of
the device
Last I would suggest for the price a protective cover should be included with the
product
It’s lightweight and allows changes in font size that enables ease of reading no
matter how tired your eyes may get
I just hope that the price goes down

The one-shot model can be used to mine suggestions when no training data is available for a domain and/or can be used to obtain training data for a classification model explained in the next section.

Explicit suggestion mining module 112 can classify objective text as explicit suggestions or not explicit suggestions. In some embodiments, explicit suggestion mining module 112 may include an evaluation task for suggestion mining, such as SemEval-2019 Task 9 Dataset, which is described by Negi et al. in Semeval-2019 task 9: Suggestion Mining from Online Reviews and Forums in Proceedings of the 13th International Workshop on Semantic Evaluation (2019) at 877-887, which are hereby incorporated by reference in their entirety. SemEval-2019 Task 9 Dataset includes dataset(s) on two domains—Software Forum Feedback and Hotel Reviews Suggestions. The challenge is formulated as two tasks—Task A and Task B. Task A contains the train and evaluation set from the same domain (software feedback forum). The software feedback forum is a dedicated forum that is used to provide suggestions for improvement in a product. The data is collected from feedback posts on the Universal Windows Platform, available on https://uservoice.com.

Task B contains the train and evaluation set from different domains (train is the same as task A and the test is from the hotel reviews domain). The hotel reviews are extracted from https://tripadvisor.com. Each of the tasks also has a trial test set which is of the same domain as the test set. The sentences in the task are labeled as suggestions if they are explicit suggestions, i.e., they can be identified as a suggestion in the absence of the rest of the review or context.

In some embodiments, a robustly optimized method for pretraining NLP systems, such as a Robustly Optimized BERT Pre-training Approach (RoBERTa) model, may be fine-tuned using the Flair Framework (see, for example, https://github.com/flairNLP/flair) on each of the tasks—Task A and Task B using the hyper parameters listed in Table 3 below.

TABLE 3
Hyperparameters for the RoBERTa Model

| Hyperparameter | Value |
|---|---|
| Learning rate | 3e-05 |
| Mini batch size | 16 |
| Epochs | 5 |
| Shuffle | True |
| Optimizer | Adam |
| Drop out | 0.1 |
| Loss | Cross entropy loss |

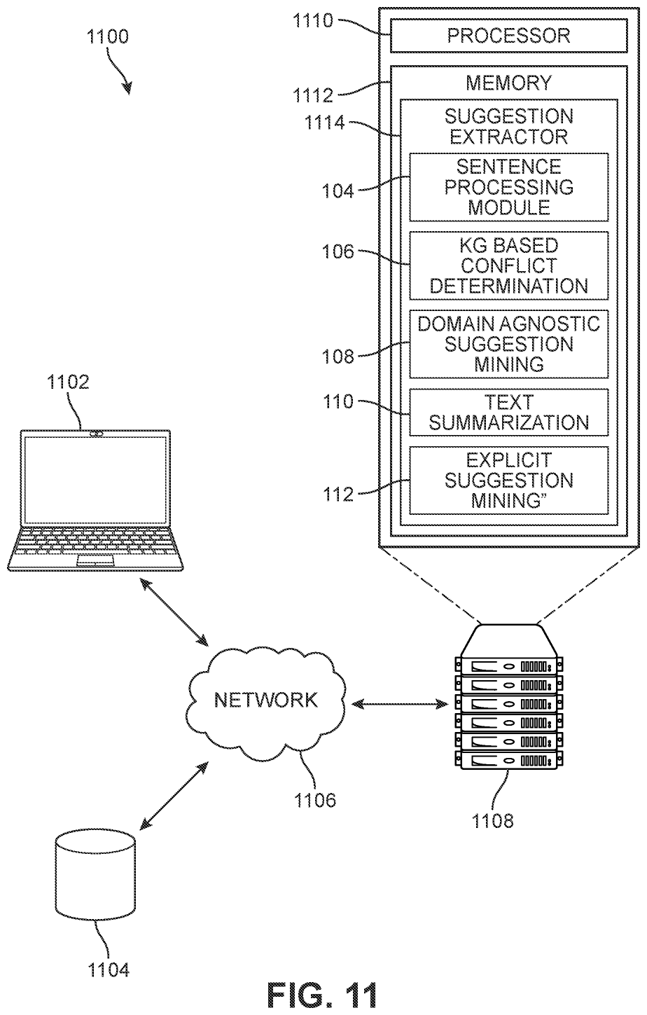

FIG. 11 is a schematic diagram of a system for extracting suggestions from review text 1100 (or system 1100), according to an embodiment. The disclosed system may include a plurality of components capable of performing the disclosed computer implemented method of extracting suggestions from review text (e.g., method 200). For example, system 1100 includes a user device 1102, a computing system 1108, a network 1106, and a database 1104.

The components of system 1100 can communicate with each other through network 1106. For example, user device 1102 may access data from database 1104 via network 1106. In some embodiments, network 1106 may be a wide area network (“WAN”), e.g., the Internet. In other embodiments, network 1106 may be a local area network (“LAN”). One or more resources of a virtual agent may be run on one or more servers. Each server may be a single computer, the partial computing resources of a single computer, a plurality of computers communicating with one another, or a network of remote servers (e.g., cloud). The one or more servers can house local databases and/or communicate with one or more external databases.

As shown in FIG. 11, a suggestion extractor 1114 may be hosted in computing system 1108, which may have a memory 1112 and a processor 1110. Processor 1110 may include a single device processor located on a single device, or it may include multiple device processors located on one or more physical devices. Memory 1112 may include any type of storage, which may be physically located on one physical device, or on multiple physical devices. In some cases, computing system 1108 may comprise one or more servers that are used to host suggestion extractor 1114. Suggestion extractor 1114 may include sentence processing module 104, knowledge graph-based conflict determination module 106, text summarization module 110, domain agnostic suggestion mining module 108, and explicit suggestion mining module 112. Database 1104 may store data that may be retrieved by other components for system 1100.

The user may include an individual using the disclosed system to extract suggestions. While FIG. 11 shows a single user device, it is understood that more user devices may be used. For example, in some embodiments, the system for extracting suggestions from review text may include two or three user devices. Other users may include, for example, customers inputting reviews on their devices. The user device may be a computing device used by a user for communicating with a virtual agent. The user device of the virtual agent may be a computing device. In some embodiments, one or more of the user devices may include a smartphone or a tablet computer. In other embodiments, one or more of the user devices may include a laptop computer, a desktop computer, and/or another type of computing device. The user devices may be used for inputting, processing, and displaying information. The user device may include a display that provides an interface for the user to input and/or view information.

Embodiments may include a non-transitory computer-readable medium (CRM) storing software comprising instructions executable by one or more computers which, upon such execution, cause the one or more computers to perform the disclosed methods. Non-transitory CRM may refer to a CRM that stores data for short periods or in the presence of power such as a memory device or Random Access Memory (RAM). For example, a non-transitory computer-readable medium may include storage components, such as, a hard disk (e.g., a magnetic disk, an optical disk, a magneto-optic disk, and/or a solid state disk), a compact disc (CD), a digital versatile disc (DVD), a floppy disk, a cartridge, and/or a magnetic tape.

Embodiments may also include one or more computers and one or more storage devices storing instructions that are operable, when executed by the one or more computers, to cause the one or more computers to perform the disclosed methods.

In some embodiments, neural network models, such as BERT (Bidirectional Encoder Representations from Transformers), may be applied to perform various NLP functions (e.g., finding synonyms or summarizing text, etc.) of the disclosed method. Flair embeddings may be additionally or alternatively applied to perform various NLP functions in various embodiments.

While various embodiments of the invention have been described, the description is intended to be exemplary, rather than limiting, and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the attached claims.

We claim:

1. A computer implemented method of extracting suggestions from review text, comprising:
receiving raw review text;
pre-processing the raw review text by applying neural parsing to the raw review text to output simplified text;
applying a Natural Language Processing (NLP) library to classify the simplified text as subjective text or objective text;
building a knowledge graph from the subjective text, wherein the knowledge graph includes noun nodes and attribute nodes;
identifying conflicting attribute nodes connected to the same noun node within the knowledge graph;
pruning the conflicting attribute nodes from the knowledge graph to create a pruned knowledge graph; and
applying a first machine learning model to the pruned knowledge graph to output a text summarization of the simplified text.

2. The method of claim 1, further comprising:
training a second machine learning model to classify explicit suggestions; and
applying the second trained machine learning model to the objective text to classify explicit suggestions.

3. The method of claim 1, wherein applying a Natural Language Processing (NLP) library to perform sentiment analysis on the simplified text includes determining a polarity of the subjective text, such that the sentiment analysis outputs simplified text labeled as subjective and negative, and simplified text labeled as subjective and positive.

4. The method of claim 3, wherein building a knowledge graph comprises:
building a negative sentiment knowledge graph from the simplified text labeled as subjective and negative, wherein the negative sentiment knowledge graph includes noun nodes and attribute nodes; and
building a positive sentiment knowledge graph from the simplified text labeled as subjective and positive, wherein the positive sentiment knowledge graph includes noun nodes and attribute nodes.

5. The method of claim 1, wherein pre-processing the raw review text comprises:
detecting one or more sentences within the raw review text; and
separating clauses within at least one sentence of the one or more sentences.

6. The method of claim 5, wherein pre-processing the raw review text comprises:
automatically spellchecking words of the one or more sentences to identify misspelled words; and
automatically correcting the identified misspelled words of the words of the one or more sentences.

7. The method of claim 1, wherein identifying conflicting attribute nodes connected to the same noun node within the knowledge graph includes applying a lexical database to find synonym and antonym information for the attribute nodes to identify conflicting attribute nodes connected to the same noun node within the knowledge graph.

8. A non-transitory computer-readable medium storing software comprising instructions executable by one or more computers which, upon such execution, cause the one or more computers to:
receive raw review text;
pre-process the raw review text by applying neural parsing to the raw review text to output simplified text;
apply a Natural Language Processing (NLP) library to classify the simplified text as subjective text or objective text;
build a knowledge graph from the subjective text, wherein the knowledge graph includes noun nodes and attribute nodes;
identify conflicting attribute nodes connected to the same noun node within the knowledge graph;
prune the conflicting attribute nodes from the knowledge graph to create a pruned knowledge graph; and
apply a first machine learning model to the pruned knowledge graph to output a text summarization of the simplified text.

9. The non-transitory computer-readable medium storing software of claim 8, wherein the instructions, upon execution, further cause the one or more computers to:
training a second machine learning model to classify explicit suggestions; and
applying the second trained machine learning model to the objective text to classify explicit suggestions.

10. The non-transitory computer-readable medium storing software of claim 8, wherein applying a Natural Language Processing (NLP) library to perform sentiment analysis on the simplified text includes determining a polarity of the subjective text, such that the sentiment analysis outputs simplified text labeled as subjective and negative, and simplified text labeled as subjective and positive.

11. The non-transitory computer-readable medium storing software of claim 10, wherein building a knowledge graph comprises:
building a negative sentiment knowledge graph from the simplified text labeled as subjective and negative, wherein the negative sentiment knowledge graph includes noun nodes and attribute nodes; and
building a positive sentiment knowledge graph from the simplified text labeled as subjective and positive, wherein the positive sentiment knowledge graph includes noun nodes and attribute nodes.

12. The non-transitory computer-readable medium storing software of claim 8, wherein pre-processing the raw review text comprises:
detecting one or more sentences within the raw review text; and
separating clauses within at least one sentence of the one or more sentences.

13. The non-transitory computer-readable medium storing software of claim 12, wherein pre-processing the raw review text comprises:
automatically spellchecking words of the one or more sentences to identify misspelled words; and
automatically correcting the identified misspelled words of the words of the one or more sentences.

14. The non-transitory computer-readable medium storing software of claim 8, wherein identifying conflicting attribute nodes connected to the same noun node within the knowledge graph includes applying a lexical database to find synonym and antonym information for the attribute nodes to identify conflicting attribute nodes connected to the same noun node within the knowledge graph.

15. A system for extracting suggestions from review text, comprising:
one or more computers and one or more storage devices storing instructions that are operable, when executed by the one or more computers, to cause the one or more computers to:
receive raw review text;
pre-process the raw review text by applying neural parsing to the raw review text to output simplified text;
apply a Natural Language Processing (NLP) library to classify the simplified text as subjective text or objective text;
build a knowledge graph from the subjective text, wherein the knowledge graph includes noun nodes and attribute nodes;
identify conflicting attribute nodes connected to the same noun node within the knowledge graph;
prune the conflicting attribute nodes from the knowledge graph to create a pruned knowledge graph; and
apply a first machine learning model to the pruned knowledge graph to output a text summarization of the simplified text.

16. The system of claim 15, wherein the instructions, upon execution, further cause the one or more computers to:
training a second machine learning model to classify explicit suggestions; and
applying the second trained machine learning model to the objective text to classify explicit suggestions.

17. The system of claim 15, wherein applying a Natural Language Processing (NLP) library to perform sentiment analysis on the simplified text includes determining a polarity of the subjective text, such that the sentiment analysis outputs simplified text labeled as subjective and negative, and simplified text labeled as subjective and positive.

18. The system of claim 15, wherein building a knowledge graph comprises:
building a negative sentiment knowledge graph from the simplified text labeled as subjective and negative, wherein the negative sentiment knowledge graph includes noun nodes and attribute nodes; and
building a positive sentiment knowledge graph from the simplified text labeled as subjective and positive, wherein the positive sentiment knowledge graph includes noun nodes and attribute nodes.

19. The system of claim 18, wherein pre-processing the raw review text comprises:
detecting one or more sentences within raw review text; and
separating clauses within at least one sentence of the one or more sentences.

20. The system of claim 19, wherein pre-processing the raw review text comprises:
automatically spellchecking words of the one or more sentences to identify misspelled words; and
automatically correcting the identified misspelled words of the words of the one or more sentences.
